(19) United States
(12) Patent Application Publication
(10) Pub. No.: US 2011/0175322 A1
(43) Pub. Date: Jul. 21, 2011

(54) Self-Steering Agriculture Grain Carts and Manure Tanks

(75) Inventors: Randy M. McMahon, Lakeville, MN (US); Frank D. Bazzoli, St. James, MN (US); Devon G. Ysker, Windom, MN (US); Scott R. Veenker, Windom, MN (US)

(73) Assignee: BALZER, INC., Mountain Lake, MN (US)

(21) Appl. No.: 12/689,903

(22) Filed: Jan. 19, 2010

(51) Int. Cl. B62D 13/00; B60D 1/44

(52) U.S. Cl. 280/442; 280/446.1

(57) ABSTRACT

A steerable axle assembly for a grain cart or manure tank unit designed to be pulled in a forward direction over and agricultural field by a farm tractor is disclosed. The invention involves a steering axle assembly that is easily guided to improve the maneuverability and safety of the unit and reduce field compaction. The steering system design features angled kingpins that transfers some of the unit weight to assist in turns. Thus, the steering system reduces the resistance of the unit steering system to turning and minimizes ground compaction during turns. The steering system is particularly designed for rear-steering grain carts and manure tank units and larger versions of such units with multiple alternating steering and non-steering axles.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates generally to grain carts and manure tanks that are not self-propelled and that are designed to be pulled behind a farm tractor. More particularly, the invention relates to a steering axle assembly designed for grain carts and manure tank trailers that facilitates turning and maneuverability while minimizing soil loading and compaction.

II. Related Art

Non-motorized trailer-mounted agriculture utility vehicles in the form of grain carts and manure tanks that are designed to be pulled behind motorized vehicles, specifically farm tractors, have been used for a long period of time. Grain carts are typically used in combination with various types of combines in grain-harvesting operations in which the grain is separated from stalks in threshing and separation steps and is first collected in a grain tank in the combine from which it is discharged through a grain tank unload tube into a grain cart pulled alongside the combine. Large capacity and easy maneuverability are desirable attributes for such grain carts inasmuch as this increases the efficiency of the grain harvesting operation. While increased capacity for grain carts is desirable, it is also desirable that the implements minimize the degree to which the soil in the field is compacted by the cart, particularly when the cart is fully loaded. An example of such a cart is shown in U.S. Pat. No. 6,488,114 B1 to McMahon et al.

Manure tanks have also long been used to distribute manure-containing mixtures over large field areas. The tanks, at times, are heavily laden and also must be highly maneuverable and need to have a minimum impact in terms of soil compaction when pulled through a field while applying the tank contents.

One important aspect of pulled grain carts and manure tanks is the ability of such vehicles to maneuver in the field while maintaining a minimum impact on the soil over which they travel. This is directly affected by the design and operation of steerable axles on such vehicles. These vehicles typically include rear-steering axles and fixed front axles in the case of two-axle vehicles and may alternate steering and fixed axles on vehicles which have three or more axles. In addition, these vehicles must have the ability to be easily pulled down roads.

A rear-steering axle assembly which utilizes an offset kingpin arrangement is shown in U.S. Pat. No. 6,267,198 B1. That axle is particularly suited for rear steering on a grain harvesting combine.

While progress has been made, there remains a need for steering axles that improve the steering function for better maneuverability and safer operation and which also reduce field compaction and allow for higher capacity loads by enabling the use of larger tires.

### SUMMARY OF THE INVENTION

By means of the present invention, there is provided a steerable axle assembly designed for utility agriculture vehicle units in the form of grain carts and manure tanks designed to be pulled in a forward direction over an agricultural field by a motorized farm tractor. The invention involves an axle assembly that is easily guided to improve the maneuverability and safety of the unit and reduce field compaction. The steering system design reduces the amount of weight of the unit concentrated on kingpins and transmitted through the wheels to the ground during turns. Thus, the steering system reduces the resistance of the unit steering system to turning and minimizes ground disturbance and compaction during turns. The steering system improves the performance of rear-steering grain carts and manure tank units having two axles and larger versions of such units with multiple alternating steering and non-steering axles.

One embodiment of the steerable axle assembly of the invention includes a pair of spaced kingpin receiver arrangements supported by a common central axle member, a spindle receiver carried by each kingpin receiver and a spindle mounted in each spindle receiver, each such spindle being adapted to carry a wheel. A kingpin is mounted in each kingpin receiver and each kingpin receiver is disposed in the structure such that a kingpin mounted in the kingpin receiver is positioned at a compound acute angle with the common central axle member, the angle being both directed inward toward the central axle member and rearward of the central axle member. Each of the spindle receivers is mounted to pivot about a kingpin. An arrangement is provided for connecting the kingpin spindle receivers together so that they operate in unison. This may be a hydraulic connection or a tie rod arrangement. In a turn, the kingpin angle causes the outward spindle in the turn to travel in an arc that pivots upward and forward to thereby facilitate the turning of the steering axle.

A damping device such as a hydraulic cylinder may be provided to bias the self-steering axle toward a neutral position in which the wheel alignment is returned to a straight ahead direction as the axle assembly comes out of a turn situation.

The self-steering axle assembly of the invention may be paired with a non-steering axle assembly to support a frame for supporting a grain cart or manure tank with the self-steering axle being the rear axle in the assembly. Larger vehicles may be provided with more than one self-steering axle. These include vehicles with three axles in which the front and rear axles are steering axles and the intermediate axle is non-steering and even larger units, for example, ones having four axles wherein the front, second and fourth axles are self-steering and the third axle is non-steering, etc.

In an alternate embodiment, the steering system of at least one steering axle in the grain cart or manure tank unit can incorporate mechanically controlled steering arrangement using a drive line shaft attached to the drawbar of a conveying vehicle such as a tractor.

### BRIEF DESCRIPTION OF THE DRAWINGS

In the drawings:

FIG. 1 is a perspective view of a grain cart support frame with a tandem axle assembly in accordance with the present invention;

FIG. 2 is a perspective view of a grain cart support frame having three independent axles in accordance with the present invention;

FIG. 3 is an exploded view of a steering kingpin system constructed in accordance with the invention;

FIG. 4 is a view of the steering kingpin system of FIG. 3 assembled attached to a fragment of a vehicle frame;

FIG. 5 is a rear elevational view of an assembled steering axle system with a tie rod connector;

FIG. 6 is a top view of an assembled steering axle system similar to that of FIG. 5 with parts removed for clarity;

FIG. 7 is a rear elevational view of an alternative embodiment of an assembled steering axle system in accordance with the invention;

FIG. 8 is a top view of a tandem assembly showing hydraulic connections and additional non-steering wheels;

FIGS. 9A-9F show top views (9A, 9C, 9E) and rear views (9B, 9D, 9F) of a steering kingpin system illustrating a right turn (9A and 9B), a straight or neutral position (9C and 9D) and a left turn (9E and 9F) with respect to a pulled vehicle illustrating the action of the kingpin steering axle system of the invention;

FIG. 10 represents a bottom perspective view of an alternative embodiment of a steerable axle system with mechanically controlled steering;

FIG. 11 is a perspective view of a grain cart having two independent axles;

FIG. 12 is a perspective view of a grain cart similar to that of FIG. 3 having three independent axles;

FIG. 13 is a perspective view of a grain cart with four independent axles;

FIG. 14 is a perspective view of a manure tank utilizing two independent axles; and

FIG. 15 is a perspective view of a manure tank including a fifth wheel setup having a tandem front axle set and three independent rear axles.

### DETAILED DESCRIPTION

In accordance with the following detailed description, there is presented one or more embodiments associated with the present inventive concepts. These embodiments are intended as examples of such concepts, but are not intended to limit the scope of the present invention in any manner as variations within the confines of the inventive concepts may occur to those skilled in the art.

As used herein, the term “axle assembly” refers to a set of opposed spaced assemblies for carrying wheels aligned on opposite sides of a vehicle frame, whether or not they are connected by a common member. Thus, the spaced assemblies may enjoy a common axle tube or other possibly unconnected mounting arrangement. The axle assemblies may be steering in which the wheels can pivot about kingpins or non-steering in which the wheels assume a fixed position. Steering axle assemblies include a connecting member or other arrangement to coordinate the turning of both wheels in unison.

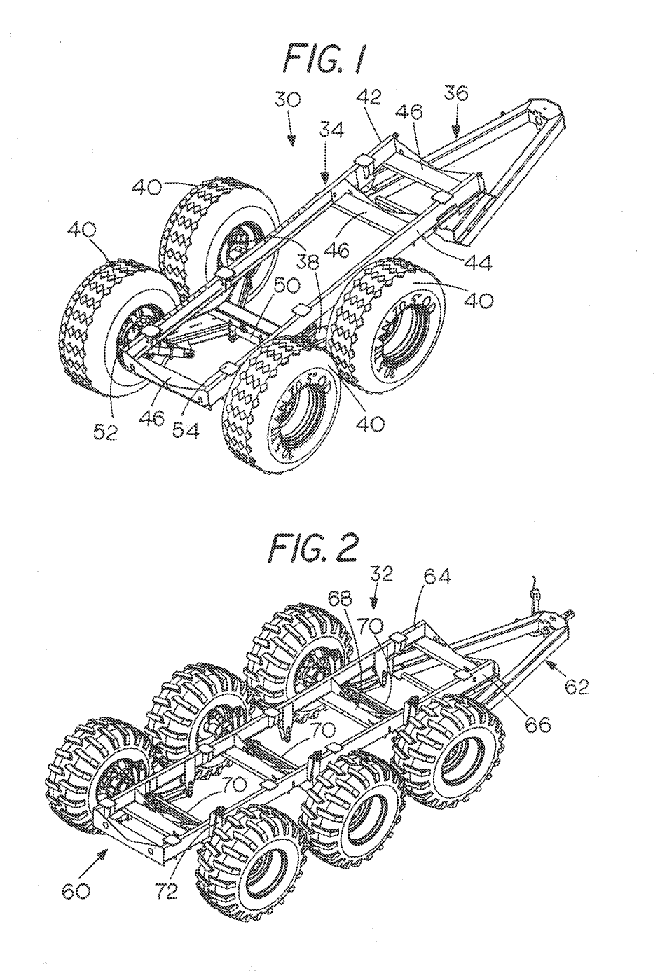

FIGS. 1 and 2 depict non-motorized grain cart support frames mounted on two (FIG. 1) and three (FIG. 2) independent axle assemblies as shown generally at 30 and 32, respectively. In FIG. 1, the grain cart 30 includes a frame 34 with an associated conventional fixed-position hitching tongue 36 secured to the frame. Non-steering wheel assemblies are partially shown at 36 and 38 with mounted tires 40. The vehicle frame further includes spaced parallel longitudinal frame members or frame rails 42 and 44 and a series of cross braces as at 46. Spaced heavy symmetrical wheel support assemblies, one of which is shown at 48, are attached to the frame and connected by common cross member 50. One of two spaced kingpin steering assemblies in accordance with the invention, and discussed in greater detail below, is shown at 52. This assembly makes up part of a steering rear axle system. The steering system embodiment of FIG. 1 includes kingpin assemblies coordinated by symmetrically opposed self-centering hydraulic cylinders, as will be explained. Support pads for carrying a bin container for a cart, a tank or the like are mounted on the frame at 54.

FIG. 2 depicts a non-motorized cart frame of an alternate, slightly different construction. It includes a frame 60 and fixed attached hitching tongue 62. The frame includes spaced parallel frame rails 64 and 66 spanned by a plurality of cross members as at 68. This vehicle includes three spaced axle systems in which the front and rear axle assemblies are steering assemblies and the intermediate assembly is non-steering. In this embodiment, the wheel-carrying assemblies are connected by heavy common cross members or axle tubes as at 70. Shock-absorbing cylinders associated with a suspension system for the axle tubes are shown at 72.

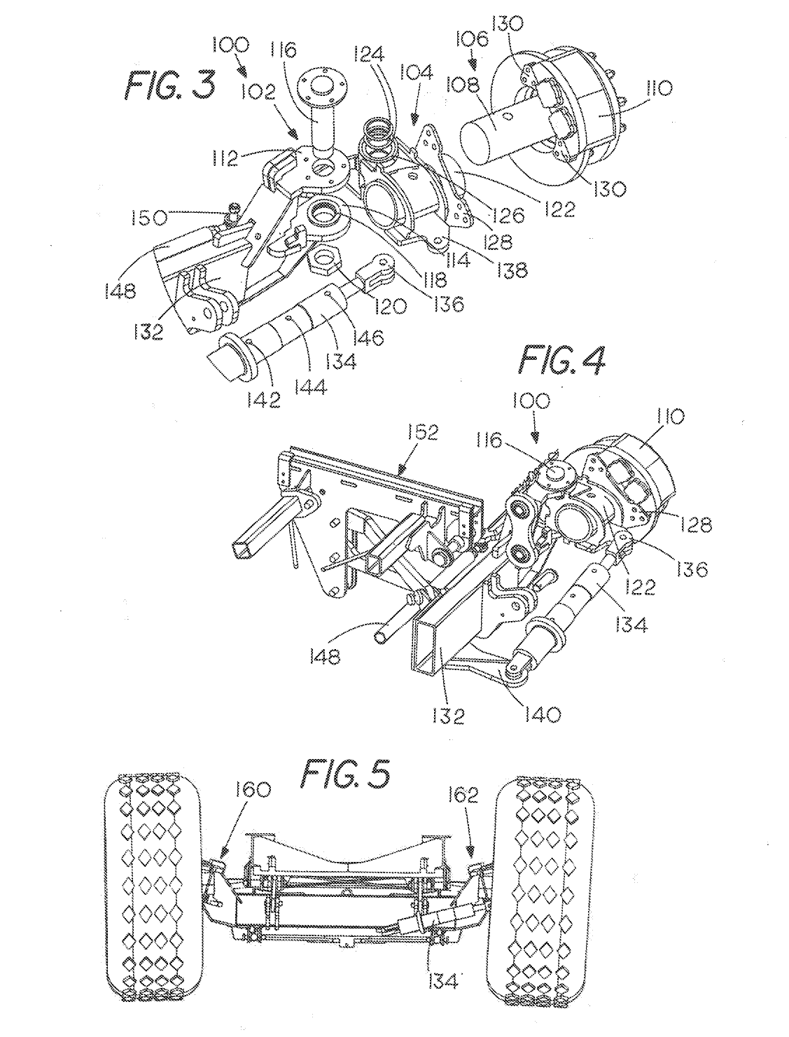

FIG. 3 depicts an exploded view of a typical kingpin steering system, generally at 100, which represents one of a pair of opposed symmetrically constructed assemblies that make up a steering axle assembly in accordance with the invention. The kingpin steering system further includes a kingpin receiver assembly 102 and a spindle receiver 104. A spindle and wheel assembly is shown at 106, including a spindle 108 and a wheel 110 mounted on the spindle. The kingpin receiver assembly further includes spaced, generally parallel, kingpin receiving members 112 and 114, which hold and position an angled kingpin 116 and also accommodate the spindle receiver 104. They also provide bearing surfaces for the assembly to operate. A lip seal member is shown at 118 on the lower bearing surface and a nut 120 secures the kingpin in place. It should also be noted that the nut clamps the upper plate 112 to the lower plate 114 causing the load of the weight of the unit to be carried more evenly.

The spindle receiver 104 includes an integral hollow spindle tube 122 for receiving a corresponding spindle member 108. The assembly further includes a series of thrust washers 124 that carry the vertical load of the vehicle and an o-ring 126 that is mounted beneath the thrust washers to seal the upper bearing surface from the environment. An attachment plate 128 cooperates with members 130 using fasteners (not shown) to attach the assemblies 104 and 106 together.

In this embodiment, the kingpin receiver assemblies are attached by intermediate structural members to a common central axle member or axle tube 132 and a fluid-operated, preferably hydraulic, steering cylinder 134 is provided having the rod end 136 mounted to the spindle receiver 104 using tab 138. The other end of the cylinder is connected to a member 140 fixed to the axle tube 132, as shown in FIG. 4.

The hydraulic cylinder 134 is actually a damping cylinder which performs two functions. First, it controls the speed at which the steering system turns and, second, the hydraulic cylinder has three hydraulic connections at 142, 144 and 146 and is pressurized to center the steering system, that is, it urges the system to assume a neutral or aligned straight forward position to allow the unit to back up or to be transported down a road easily, for example, with the spindles in what amounts to a locked position.

This embodiment also includes a tie rod 148 connected between the spindle receivers 104, one connector of which is shown at 150. The tie rod forces the spindle receivers to operate (pivot) in unison by mechanical connection.

The system of FIG. 3 is shown assembled in FIG. 4 and attached to a fragment of a vehicle frame at 152.

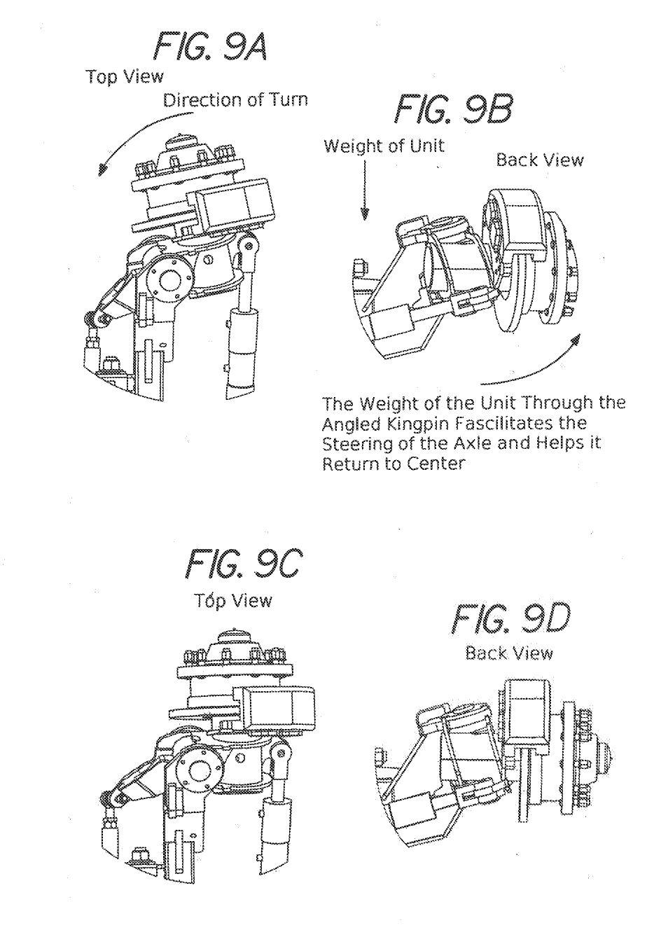

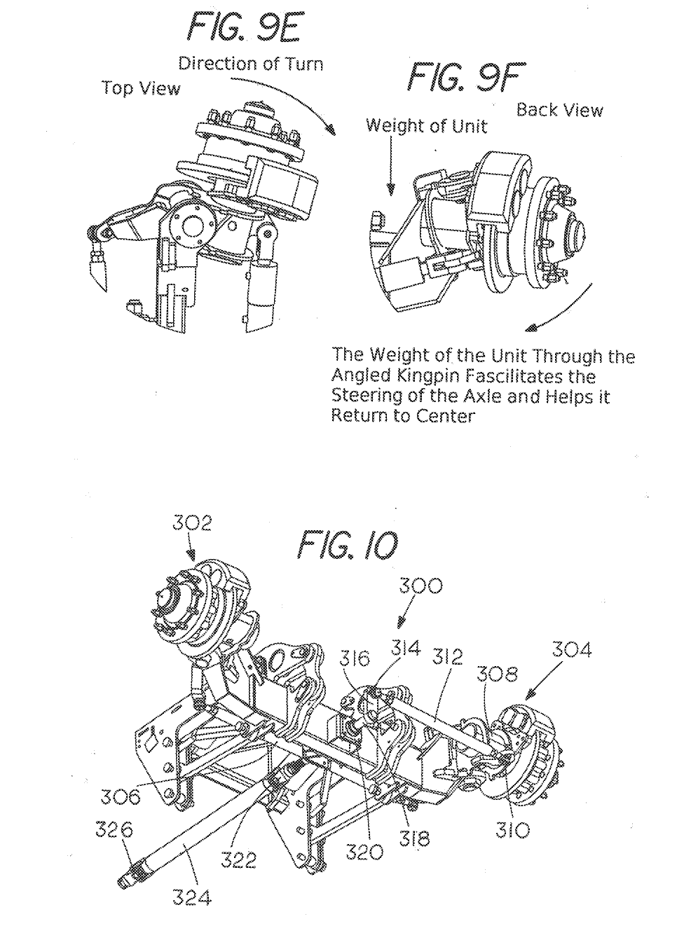

FIGS. 5 and 6 show rear elevational and top views of steering axle assemblies in accordance with the embodiment of FIGS. 3 and 4. As can be seen from the figures, a key feature of the kingpin steering system of the invention lies in the mounting disposition of the kingpins. The kingpins are disposed at a compound acute angle with the common axle tube or other support member such that the kingpins are disposed to extend in a rearward and inward manner rather than being mounted in a conventional vertical plane. An important aspect of the invention is the mounting of the kingpins at a compound angle that allows the spindles to travel in an arc that wants to pivot up and forward with the weight of the unit resting on the bearing surfaces. The tie rod 148 that connects the left kingpin steering system, including the left spindle assembly, shown at 160 in FIGS. 5 and 6, with the right kingpin steering system 162 using respective connectors 164 and 166, as shown in FIG. 6 causes the spindles to operate in unison. This is further illustrated in the turning, straightening and opposite direction turning sequences depicted in FIGS. 9A-9F. Easy turning and relief of stress on the kingpins is accomplished as the spindle receivers, and so the spindles rotate in a plane perpendicular to the disposition of the kingpins, rather than in a flat trajectory accommodated by the normal vertical disposition of kingpins.

In addition, this configuration reduces ground traveling in turns and further enables the vehicle to accommodate larger tires, typically up to two meters in diameter or greater, thereby reducing ground loading even more.

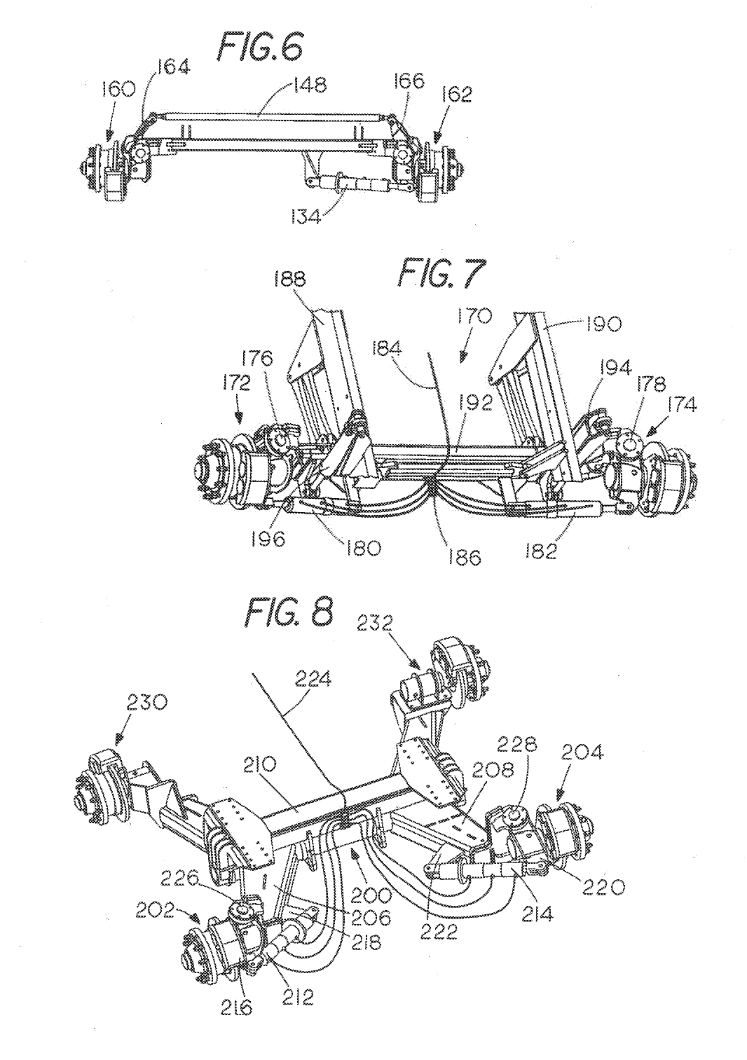

FIG. 7 is a top view of an alternative embodiment of an assembled single steering axle system in accordance with the invention. The steering axle is shown generally at 170 and includes spaced symmetrically opposed and otherwise identical kingpin steering assemblies for steering as at 172 and 174 that include compound angled kingpins 176 and 178 respectively. The kingpins are attached to the frame and coordinated by two separate hydraulic cylinders 180 and 182 supplied from a common hydraulic fluid line 184 and common connector 186. The common hydraulic connection enables the cylinders 182 and 182 to act in the manner of a tie rod to coordinate the turning of assemblies 172 and 174 as was the case with the damping cylinder of FIGS. 3-5, the cylinders 182 and 182 act to return the assemblies to a forward directed position. Fragments of frame members are shown at 188 and 190 with cross brace 192 and shock absorbing suspension devices are shown at 194 and 196.

FIG. 8 is a top view of a tandem axle assembly also showing similar hydraulic connections. The steering axle assembly is shown generally at 200 and includes steering spaced, opposed symmetrically constructed kingpin assemblies at 202 and 204. These assemblies are attached to structural members 206 and 208, respectively, which, in turn, attach to a common structural member 210. This system also features a pair of hydraulic steering cylinders 212 and 214. Cylinder 212 connects a corresponding pivoting spindle receiver 216, a structural member 206 using a plate member 218. Likewise, cylinder 214 connects pivoting spindle receiver 220 with member 208 using a member 222. The cylinders 212 and 214 are provided with hydraulic fluid from a common source 224 in a manner that coordinates both cylinders to operate together and also pressurizes the cylinders to center to stabilize the steering system so that it favors locking the spindles in a forward position.

In this embodiment, note that the kingpins 226 and 228 are disposed at the same angle as those enumerated with respect to the previously described embodiments. Additional non-steering or fixed position assemblies are shown at 230 and 232, which are also structurally attached to the forward portion of common member 210 through an intermediate structure. As can be seen from the drawing, the assemblies 230 and 232 are fixed in a neutral or straightforward position.

FIG. 10 represents a bottom perspective view of an alternative embodiment of a steerable axle system that employs mechanically controlled steering. The system, shown generally at 300, includes angled kingpin steering systems at 302 and 304 with common tie rod 306. The kingpin steering system 304 includes a spindle receiver 308 connected at 310 to a second tie rod 312 which, in turn, is attached at 314 to an eccentric steering arm 316 instead of to a hydraulic cylinder, as shown in the embodiment of FIGS. 3-6, for example. The steering arm 316 is attached to a steering shaft 318 that rotates and operates the eccentric steering arm 316. The shaft 318 is held by bearings as at 320 and extends to be connected by a universal joint 322 to a drive line shaft 324. The drive line locks and controls the amount of steering available in the axle system and is, in turn, connected via a second universal joint 326 to the draw bar of a tractor or other motorized pulling vehicle. In this manner, the act of the tractor turning transfers the necessary torque to the steering axle to rotate the system in the correct amount in the direction. Both kingpin assemblies are coordinated via the connection with common tie rod 306 and the kingpins are set at an angle as per previous embodiments.

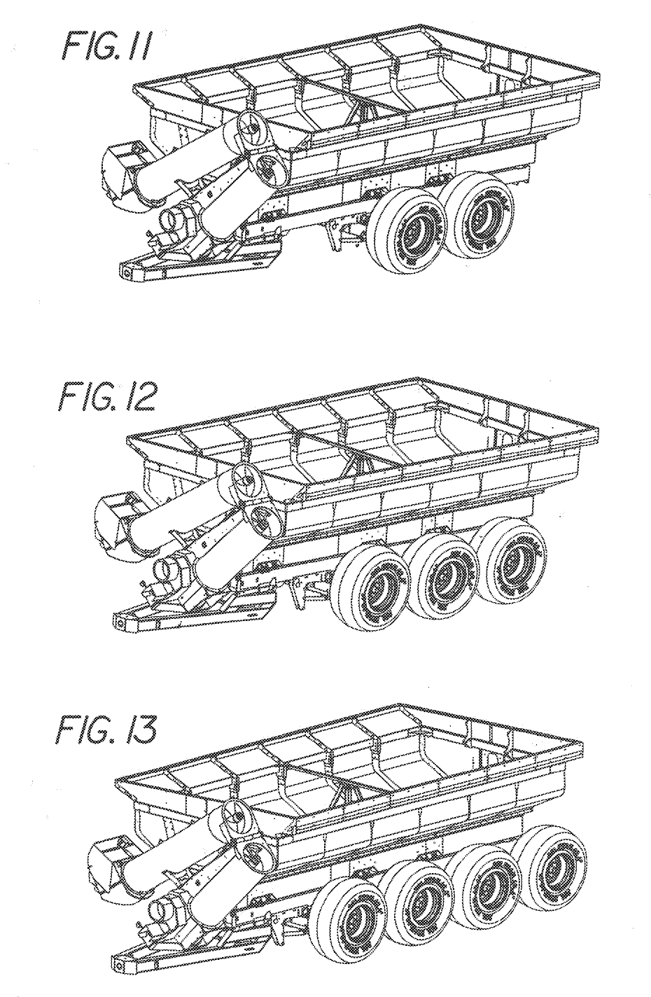

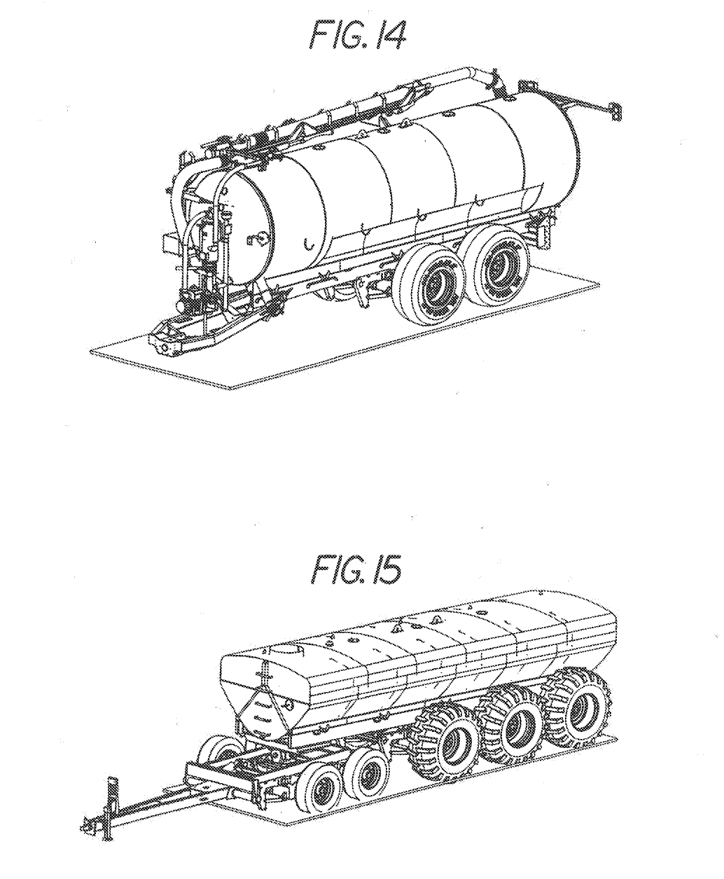

The remaining drawing figures depict various non-motorized agriculture implement grain cart and manure tank units suitable for use with the steering systems and combination axle systems of the present invention. Thus, FIG. 11 is a perspective view of a grain cart having two tandem independent axles. FIG. 12 is a perspective view of a grain cart similar to that depicted in FIG. 11, but provided with three independent axles. In this arrangement, normally the front and rear axles would be steering axles and the intermediate axle fixed. FIG. 13 depicts a grain cart similar to those shown in FIGS. 11 and 12 provided with a four-axle arrangement in which the second and fourth or first, second and fourth axles may be steering axles. FIG. 14 is a perspective view of a manure tank with two independent axle systems, the rear axle system of which is a steering axle. Finally, FIG. 15 is a perspective view of a manure tank having a fifth wheel setup utilizing a tandem front axle set in conjunction with three rear axle sets, the initial and final ones of which typically are steering axles, with the intermediate axle being fixed.

It will be appreciated that the steering axle arrangement of the present invention lends itself for use with any combination of steering and non-steering axles in grain carts and manure tanks designed to be pulled in a forward direction by a motorized conveyance.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A self-steering agricultural vehicle selected from grain carts and manure tanks, or the like, and designed to be pulled in a forward direction by a farm tractor, or the like, comprising:
(a) a frame for supporting a load and an attached undercarriage arrangement including a plurality of axle assemblies;
(b) at least one self-steering axle assembly further comprising:
(1) a pair of spaced kingpin receiver arrangements supported by a common central axle member and a spindle receiver carried by each kingpin receiver and a spindle mounted in each spindle receiver, each said spindle being adapted to carry a wheel;
(2) a kingpin mounted in each kingpin receiver, each kingpin receiver being configured such that a kingpin mounted therein is disposed at a compound acute angle with the common central axle member, said angle being both directed inward toward said central axle member and rearward of said central axle member, each spindle receiver being adapted to pivot about a kingpin;
(3) connecting system for causing said spindle receivers to operate in unison; and
(4) wherein said kingpin angle causes an outward spindle to travel in an arc that pivots upward and forward in a turn thereby facilitating the turning of the self-steering axle.

2. A grain cart or manure tank vehicle as in claim 1 further comprising a damping device connected to bias said self-steering axle toward wheel alignment in a straight ahead direction.

3. A grain cart or manure tank vehicle as in claim 2 wherein said damping device includes a fluid cylinder.

4. A grain cart or manure tank vehicle as in claim 3 wherein said fluid cylinder is a hydraulic cylinder.

5. A grain cart or manure tank vehicle as in claim 1 wherein said connecting system comprises a tie rod member connected between said spindle receivers.

6. A grain cart or manure tank vehicle as in claim 1 wherein said connecting system comprises a fluid operated device connecting said spindle receivers.

7. A grain cart or manure tank vehicle as in claim 1 wherein each said kingpin receiver further comprises spaced upper and lower plates and a thrust washer assembly and wherein each said spindle receiver is mounted therebetween to rotate about said kingpin.

8. A grain cart or manure tank vehicle as in claim 1 wherein said vehicle comprises two axles and said self-steering axle is a rear axle.

9. A grain cart or manure tank vehicle as in claim 1 wherein said vehicle comprises three axles and said front and rear axles are self-steering axles.

10. A grain cart or manure tank vehicle as in claim 1 comprising four axles wherein said front, second and fourth axles are self-steering and said third axle is non-steering.

11. A grain cart or manure tank vehicle as in claim 1 further comprising horizontally spaced drag link bars connecting each end of each central axle member of each self-steering axle assembly with said frame to maintain spacing and alignment of each said central axle member with respect to said frame.

12. A grain cart or manure tank vehicle as in claim 1 wherein one of said axles is a tag axle that can be selectively deployed.

13. An agricultural vehicle selected from the group consisting of grain carts and manure tanks designed to be pulled in a forward direction by a farm tractor, or the like, comprising:
(a) a frame for supporting a load and an attached undercarriage arrangement including a plurality of axle assemblies;
(b) at least one self-steering axle assembly further comprising:
(1) a pair of spaced kingpin receiver arrangements mounted on a common central axle member and a spindle receiver carried by each kingpin receiver and a spindle mounted in each spindle receiver, each said spindle being adapted to carry a wheel;
(2) a kingpin mounted in each kingpin receiver, each kingpin receiver being such that a kingpin mounted therein is disposed at a compound acute angle with the common central axle member, said angle being both directed inward toward said central axle member and rearward of said central axle member, each spindle receiver being adapted to pivot about a kingpin;
(3) a connecting system for causing said spindle receivers to operate in unison;
(4) wherein said kingpin angle causes an outward spindle to travel in an arc that pivots upward and forward in a turn thereby facilitating the turning of the self-steering axle; and
(c) a steering device for operating said steering axle connected to pivot one of said spindle receivers.

14. A grain cart or manure tank vehicle as in claim 13 wherein each said kingpin receiver further comprises spaced upper and lower plates and a thrust washer assembly and wherein each said spindle receiver is mounted therebetween to rotate about said kingpin.

15. A grain cart or manure tank vehicle as in claim 13 comprising a steering device having a rotating shaft which operates a crank arm and associated steering rod.

16. A grain cart or manure tank vehicle as in claim 15 wherein said steering shaft is attached to the drawbar of a hauling vehicle.
